(19) United States
(12) Patent Application Publication
(10) Pub. No.: US 2026/0093651 A1
(43) Pub. Date: Apr. 2, 2026

(54) TEST ADAPTER DEVICE

(71) Applicant: Hosin Global Electronics Co., LTD, Shenzhen (CN)

(72) Inventors: Chien-Yuan Yao, Shenzhen (CN); Tun-Kai Chang, Shenzhen (CN); Chia-Yu Chang, Shenzhen (CN)

(73) Assignee: Hosin Global Electronics Co., LTD, Shenzhen (CN)

(21) Appl. No.: 19/270,413

(22) Filed: Jul. 15, 2025

(30) Foreign Application Priority Data
Sep. 30, 2024 (CN) 202422397984.3

(51) Int. Cl. G06F 13/38; G06F 13/42

(52) U.S. Cl. CPC G06F 13/382; G06F 13/4221; G06F 13/4282; G06F 2213/0026; G06F 2213/0042

(57) ABSTRACT

A test adapter device includes: a USB hub module having multiple USB interfaces; multiple PCIe slots, each including multiple lanes grouped into lane groups; multiple interface adapter modules, each connected to one lane group of one PCIe slot and one USB interface for signal conversion; multiple switch modules to control a power supply state of the corresponding interface adapter module; and the control switch module connected to a host system and the switch module, controlling a state of the switch module according to a received test instruction, thereby selectively controlling power supply of the interface adapter module.

### CROSS-REFERENCE TO RELATED APPLICATION

This application claims the priority benefit of China application serial no. 202422397984.3, filed on Sep. 30, 2024. The entirety of the above-mentioned patent application is hereby incorporated by reference herein and made a part of this specification.

### BACKGROUND

### Technical Field

The disclosure relates to a field of a storage device testing technology, and more particularly, to a test adapter device for testing multiple storage devices.

### Description of Related Art

With the development of computer technology, solid-state drives with peripheral component interconnect express (PCIe) interfaces have been widely used in various electronic devices. However, the solid-state drives with the PCIe interfaces usually do not support a hot-plugging function, which brings difficulties to testing and verification on a production line. Existing testing methods often require that the solid-state drives be functionally verified without powering off a test computer, and an external interface of the test computer generally does not have a PCIe slot. In addition, due to limitation on transmission bandwidths, it is currently difficult to verify the solid-state drives at the same time, which seriously affects test efficiency.

Therefore, there is an urgent need for a test adapter device that may support hot-plugging of the solid-state drives with the PCIe interfaces and may test multiple storage devices in parallel at the same time to improve the test efficiency and resource utilization.

### SUMMARY

An objective of the disclosure is to provide a test adapter device for testing multiple storage devices, so as to solve a technical issue in the related art that the storage device with a PCIe interface is difficult for hot-plugging and difficult for parallel testing on the storage devices.

One or more embodiments of the disclosure provide a test adapter device, suitable for testing multiple storage devices. The test adapter device includes: a USB hub module electrically connected to a host USB interface of a host system, in which the USB hub module includes multiple USB interfaces; multiple PCIe slots supporting a peripheral component interconnect express standard and configured to be electrically connected to multiple storage devices to be tested, in which each of the PCIe slots includes multiple lanes, and the lanes of each of the PCIe slots are grouped into multiple lane groups; multiple interface adapter modules, in which a first interface of each of the interface adapter modules is electrically connected to one of the lane groups of one of the PCIe slots, and a second interface is electrically connected to one of the USB interfaces, in which each of the interface adapter modules is configured for signal conversion between one of the lane groups in the PCIe slot and the USB interface; multiple switch modules electrically connected to the interface adapter modules respectively to control a power supply state of the corresponding interface adapter module; and a control switch module electrically connected to the host system and the switch modules to control a switch state of each of the switch modules. The control switch module sends a control signal to control the switch state of each of the switch modules according to a test instruction received from the host system, and selectively controls the power supply state of each of the interface adapter modules to enable multiple target lane groups of the PCIe slots corresponding to test requirements, thereby performing a test operation on the storage devices to be tested that are electrically connected to the PCIe slots.

In one or more embodiments of the disclosure, the control switch module includes: multiple control signal output ends electrically connected to the switch modules to transmit multiple control signals to the switch modules respectively, so as to control the different switch states of the switch modules. Each of the control signals includes a first level or a second level.

In one or more embodiments of the disclosure, the control switch module includes: one or more inverters disposed between an output end of the control switch module for outputting a control signal and the switch modules to convert the control signal that is input into an inverse control signal, so that some of the switch modules among the switch modules receive the inverse control signal, thereby controlling the different switch states of the switch modules at the same time through the single control signal.

In one or more embodiments of the disclosure, the control signals received by the lane groups of each of the PCIe slots with same sequence numbers are the same.

In one or more embodiments of the disclosure, the test adapter device further includes: a power input module externally connected to an external power source to provide power to the interface adapter modules. The power input module is electrically connected to the interface adapter modules respectively through the switch modules.

In one or more embodiments of the disclosure, each of the switch modules includes: a first switch transistor; a second switch transistor; a power input end configured to be connected to the power input module; and a power output end configured to be connected to the corresponding interface adapter module. A first node of the first switch transistor is connected to the power input end. A second node of the first switch transistor is connected to the power output end. A second node of the second switch transistor is connected to a control end of the first switch transistor. A first node of the second switch transistor is grounded. A control end of the second switch transistor is configured to receive the control signal or the inverse control signal output by the control switch module.

In one or more embodiments of the disclosure, the first switch transistor is a PMOS transistor. The first node of the first switch transistor is a source of the PMOS transistor. The second node of the first switch transistor is a drain of the PMOS transistor. The control end of the first switch transistor is a gate of the PMOS transistor. The second switch is an NMOS transistor. The first node of the second switch transistor is a source of the NMOS transistor. The second node of the second switch transistor is a drain of the NMOS transistor. The control end of the second switch transistor is a gate of the NMOS transistor.

In one or more embodiments of the disclosure, the switch module further includes: a first resistor, a second resistor, a third resistor, a first capacitor, and a second capacitor. The drain of the NMOS transistor is connected to the power input end through the first resistor. The drain of the NMOS transistor is connected to the gate of the PMOS transistor through the second resistor. A first end of the first capacitor is connected between the source of the PMOS transistor and the power input end, and a second end of the first capacitor is grounded. A first end of the second capacitor is connected between the drain of the PMOS transistor and the power output end, and a second end of the second capacitor is grounded. A first end of the third resistor is connected between the drain of the PMOS transistor and the power output end, and a second end of the third resistor is grounded.

In one or more embodiments of the disclosure, the USB hub module further includes: an upstream interface configured to be connected to the host USB interface; a hub control module configured to manage data flow; and a high-speed routing module configured to distribute data from the hub control module to the corresponding USB interface according to an instruction of the hub control module.

In one or more embodiments of the disclosure, a total number of the lanes grouped into the same lane group is a first number, and the first number is a maximum number of the lanes supported without exceeding a limit of a maximum supported bandwidth of each of the USB interfaces.

Based on the above, the disclosure provides the test adapter device for testing the storage devices, which achieves the following beneficial effects through an innovative design of the combination of the interface adapter module (e.g., the PCIe to USB module), the control switch module, and the switch module. The simulated hot-plugging function: Through power control, simulated hot-plugging of the storage device with the PCIe interface is implemented, which improves test flexibility and efficiency while reducing hardware loss; parallel testing capability: supporting testing on the storage devices at the same time, which significantly improves testing efficiency; flexible resource allocation: using a lane grouping method to implement flexible resource allocation and management according to bandwidth characteristics of the USB interface and PCIe lane; strong compatibility: supporting multiple PCIe and USB standards and adapting to the storage devices of different specifications and generations; precise control: Through the control switch module and the switch module, precise control of each of the PCIe to USB modules is implemented, which improves system reliability and test flexibility.

In order for the aforementioned features and advantages of the disclosure to be more comprehensible, embodiments accompanied with drawings are described in detail below.

### BRIEF DESCRIPTION OF THE DRAWINGS

FIG. 1 is a block diagram of a test system according to an embodiment of the disclosure.

FIG. 2 is a block diagram of a test adapter device according to an embodiment of the disclosure.

FIG. 3 is another block diagram of a test adapter device according to an embodiment of the disclosure.

FIG. 4 is a block diagram of a test adapter device according to another embodiment of the disclosure.

FIG. 5 is a schematic circuit diagram of a switch module according to an embodiment of the disclosure.

FIG. 6 is a block diagram of a host system according to an embodiment of the disclosure.

FIG. 7 is a block diagram of a USB hub module according to an embodiment of the disclosure.

### DETAILED DESCRIPTION OF DISCLOSED EMBODIMENTS

Reference will now be made in detail to the exemplary embodiments of the disclosure, and examples of the exemplary embodiments are illustrated in the accompanying drawings. Whenever possible, the same reference numerals are used in the drawings and descriptions to indicate the same or similar parts. It is to be understood that both the foregoing and other detailed descriptions, features and advantages are intended to be described more comprehensively by providing an embodiment accompanied with the drawings hereinafter. Directional terms used in the following embodiments, such as upper, lower, left, right, front, and rear merely refer to directions in the accompanying drawings. Therefore, the directional terms are used to illustrate rather than limit the disclosure.

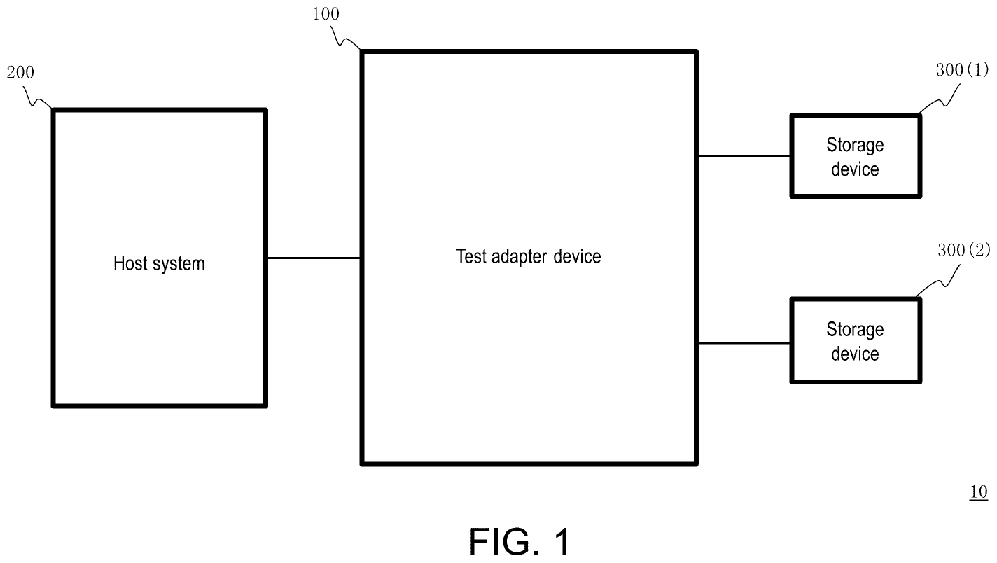

FIG. 1 is a block diagram of a test system according to an embodiment of the disclosure.

Referring to FIG. 1, in an embodiment, as shown in FIG. 1, the disclosure provides a test system 10 used to test multiple storage devices. The test system 10 includes a host system 200, a test adapter device 100, and multiple storage devices 300 (e.g., storage devices 300(1) to 300(2)).

The host system 200 is used to control an entire test process, send a test instruction, and send and receive test data, so as to analyze a test result. The host system 200 may be a computer or a dedicated test control device, in which test control software is installed to manage the test process, analyze the test data, and generate a test report.

The test adapter device 100 is a core part of the disclosure, which is connected between the host system 200 and the storage devices 300 to perform an actual test operation. The test adapter device 100 includes various modules, such as a universal serial bus (USB) hub module, multiple peripheral component interconnect express (PCIe) slots, multiple interface adapter modules, multiple switch modules, and a control switch module. The test adapter device 100 receives the test instruction from the host system 200, and controls a test process of the storage device 300 and switching of lanes according to the instruction. In this embodiment, the interface adapter module is, for example, a PCIe to USB module.

The storage devices 300(1), 300(2), etc. represent multiple storage devices to be tested, which are usually solid-state drives with PCIe interfaces. The storage devices are connected to a system through the PCIe slots in the test adapter device 100. FIG. 1 exemplarily shows two storage devices, but in fact the system may support a greater number of storage devices for testing at the same time.

For example, in an embodiment, an operation process of the test system 10 is, for example:
(1). The host system 200 sends the test instruction to the test adapter device 100.
(2). The control switch module in the test adapter device 100 receives and analyzes the test instruction.
(3). The control switch module generates a control signal according to the instruction and controls a power supply state of the corresponding interface adapter module through the switch module.
(4). The enabled interface adapter module (the PCIe to USB module) starts working and converts a PCIe signal into a USB signal.
(5). The converted signal is transmitted back to the host system 200 through the USB hub module.
(6). The host system 200 receives the test data and performs analysis and processing.
(7). In the test process, different storage devices 300 or lane groups may be switched for testing according to requirements.
(8). After the test is completed, the host system 200 generates the test report.

A design of this system architecture allows parallel testing on the storage devices 300 at the same time, greatly improving test efficiency. At the same time, since a technical solution of PCIe to USB is used, the storage device with the PCIe interface that originally does not support hot plugging may achieve a hot-plugging function similar to that of a USB device, which is convenient for device replacement and management in the test process.

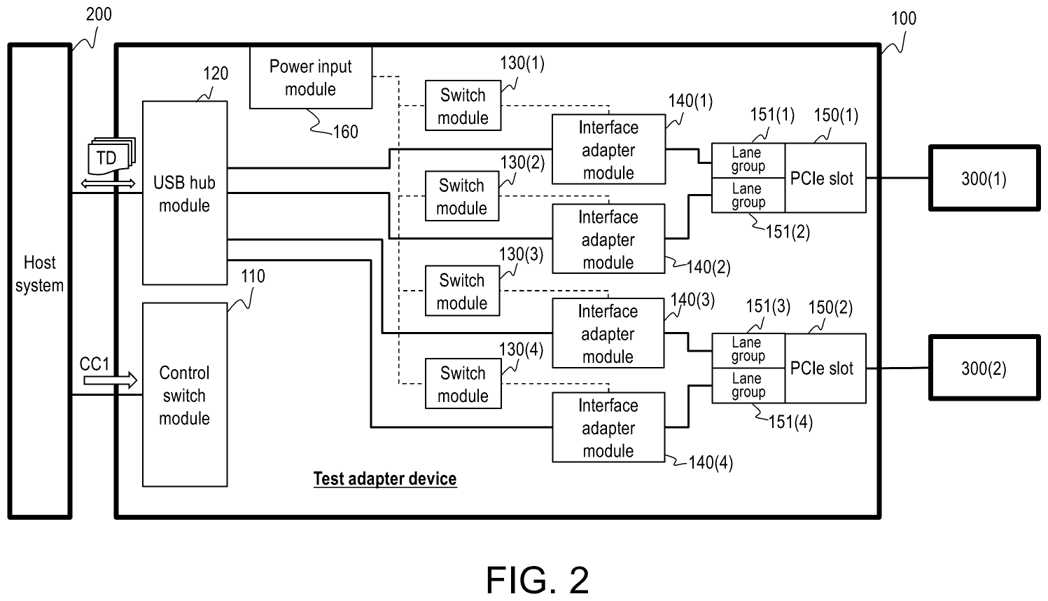

FIG. 2 is a block diagram of a test adapter device according to an embodiment of the disclosure.

In an embodiment, as shown in FIG. 2, the disclosure provides the test adapter device 100 used to test the storage devices. The test adapter device 100 includes a USB hub module 120, multiple PCIe slots 150(1) to 150(2), multiple interface adapter modules (also called PCIe to USB modules) 140(1) to 140(4), multiple switch modules 130(1) to 130(4), a control switch module 110, and a power input module 160.

The USB hub module 120 is electrically connected to a host USB interface of the host system 200 to establish a data channel to transmit and receive test data TD. The USB hub module 120 includes multiple USB interfaces to be connected to the interface adapter modules 140(1) to 140(4) respectively.

The test adapter device 100 includes the PCIe slots 150(1) and 150(2) to be electrically connected to the storage devices 300(1) and 300(2) to be tested. Each of the PCIe slots includes multiple lanes, and the lanes are grouped into multiple lane groups (for example, one PCIe slot has four lanes, and one lane group may have two lanes). Specifically, the PCIe slot 150(1) includes lane groups 151(1) and 151(2), and the PCIe slot 150(2) includes lane groups 151(3) and 151(4).

In the interface adapter modules 140(1), 140(2), 140(3), and 140(4), a first interface of each of interface adapter modules 140 is electrically connected to one lane group 151 of one PCIe slot 150, and a second interface is electrically connected to one USB interface of the USB hub module 120. Each of the interface adapter modules 140 is used for signal conversion between one lane group in the PCIe slot and the USB interface. For example, a PCIe signal from one lane group 151 is converted into a USB signal, and the USB signal is input to the corresponding USB interface of the USB hub module 120.

The switch modules 130(1), 130(2), 130(3), and 130(4) are electrically connected to the interface adapter modules 140(1), 140(2), 140(3), and 140(4) respectively to control a power supply state of the corresponding interface adapter module 140. The test adapter device 100 further includes the power input module 160 externally connected to an external power source to provide power to the interface adapter modules 140(1) to 140(4). The power input module 160 is electrically connected to the interface adapter modules 140(1) to 140(4) respectively through the switch modules 130(1) to 130(4).

The control switch module 110 is electrically connected to the host system 200 and the switch modules 130(1) to 130(4) to control a signal to control a switch state of each of the switch modules 130. The control switch module 110 generates and sends a control signal corresponding to a test instruction CC1 according to the test instruction CC1 received from the host system 200 to control the switch state of each of the switch modules 130(1) to 130(4), so as to selectively control the power supply state of each of the interface adapter modules 140, so that a target lane group of a target PCIe slot that meets test requirements may send and convert the test data through the powered interface adapter module, thereby performing the test operation on a target storage device electrically connected to the powered PCIe slot.

In an embodiment, a connection relationship and interaction between the modules are as follows:

The host system 200 is connected to the USB hub module 120 and the control switch module 110 through the host USB interface to send and receive the test data and analyze the test result. At the same time, the host system 200 sends the test instruction CC1 to the control switch module 110.

The control switch module 110 is connected to the switch modules 130(1) to 130(4) to control the switch state of each of the switch modules 130.

The USB hub module 120 is connected to the four interface adapter modules 140(1) to 140(4) respectively to transmit the converted USB signal to the host system 200.

Each of the switch modules 130(1) to 130(4) is connected to the corresponding interface adapter modules 140(1) to 140(4) respectively to control the power supply states thereof.

The interface adapter modules 140(1) and 140(2) are respectively connected to the lane groups 151(1) and 151(2) of the PCIe slot 150(1). The interface adapter modules 140(3) and 140(4) are respectively connected to the lane groups 151(3) and 151(4) of the PCIe slot 150(2).

The PCIe slots 150(1) and 150(2) are respectively connected to the storage devices 300(1) and 300(2) to perform actual data transmission and test operations on the connected storage devices.

The power input module 160 is connected to all the switch modules 130(1) to 130(4) and provides the power to the interface adapter modules 140(1) to 140(4).

In an embodiment, the host system 200 first sends the test instruction CC1 to the control switch module 110. After analyzing the instruction, the control switch module 110 generates the corresponding control signals to be sent to the switch modules 130(1) to 130(4). The switch module changes the state thereof according to the control signal, thereby controlling power supply of the corresponding interface adapter modules 140(1) to 140(4). The enabled interface adapter module converts the PCIe signal from the storage device 300(1) or 300(2) received from the PCIe slot 150(1) or 150(2) into the USB signal, and then transmits the signal to the host system 200 through the USB hub module 120 for processing and analysis.

This design allows flexible control of test states of different lane groups and implementing the parallel testing on the storage devices, while achieving the hot-plugging function of the storage device with the PCIe interface through PCIe to USB conversion, which greatly improves the test efficiency and system flexibility.

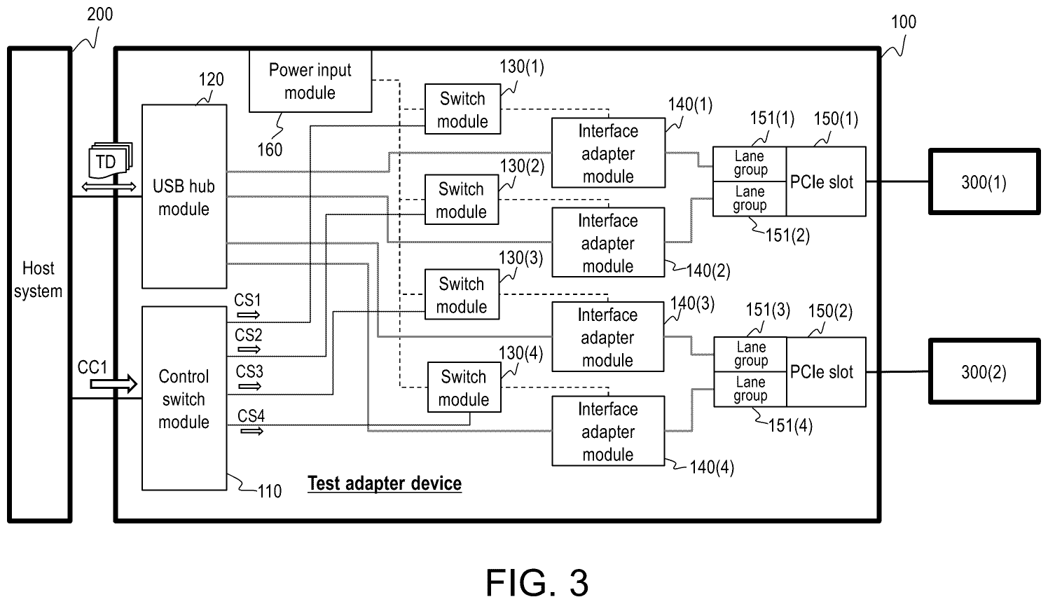

FIG. 3 is another block diagram of a test adapter device according to an embodiment of the disclosure.

Referring to FIG. 3, continuing from the example of FIG. 2, FIG. 3 focuses on illustrating the connection relationship and interaction between the control switch module 110 and the switch modules 130(1) to (4). In an embodiment, the control switch module includes multiple control signal output ends electrically connected to the switch modules to respectively transmit multiple control signals to the switch modules, so as to control different switch states of the switch modules. Each of the control signals includes a first level or a second level.

In more detail, the control switch module 110 includes the control signal output ends, and the control signal output ends are electrically connected to the switch modules 130(1), 130(2), 130(3), and 130(4) respectively. Each of the control signal output ends is used to transmit control signals CS1, CS2, CS3, and CS4 to the corresponding switch modules 130(1), 130(2), 130(3), and 130(4) to control the switch states of the switch modules.

In the actual operation, the control switch module 110 sends the control signals CS1, CS2, CS3, and CS4 to the switch modules 130(1), 130(2), 130(3), and 130(4) respectively through the control signal output ends according to the test instruction received from the host system 200. The control signals may be high-level signals (also called the first level) or low-level signals (also called the second level) to control an on or off state of the corresponding switch module. For example, when CS1 outputs the high-level signal, the switch module 130(1) is turned on, allowing the power to flow from the power input module 160 to the interface adapter module 140(1); when CS1 outputs the low-level signal, the switch module 130(1) is turned off, and the power supply of the interface adapter module 140(1) is cut off.

This design allows the control switch module 110 to flexibly control a working state of each of the interface adapter modules 140, thereby implementing selective testing on different lane groups. For example, the interface adapter modules 140(1) and 140(3) may be enabled at the same time to perform the parallel testing on some lanes of the storage devices 300(1) and 300(2), while the interface adapter modules 140(2) and 140(4) are kept in a disabled state.

It is worth mentioning that in an embodiment, in order to save the number of configurations of the control signal output ends, the control switch module further includes one or more inverters disposed between the output end of the control switch module for outputting the control signal and the switch modules to convert the control signal that is input into an inverse control signal, so that some of the switch modules among the switch modules receive the inverse control signal, thereby controlling the different switch states of the switch modules at the same time through the single control signal.

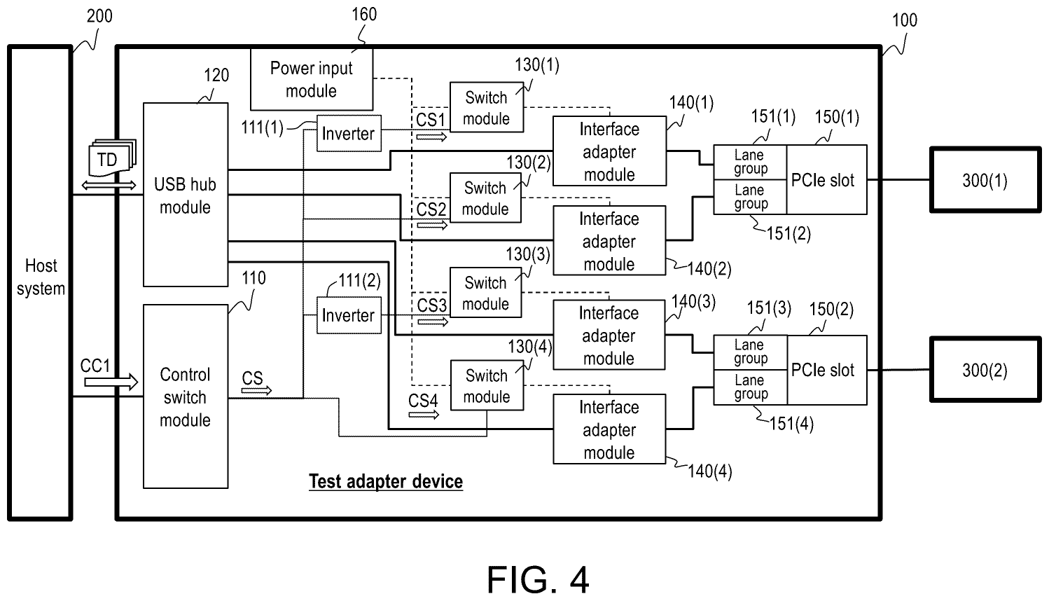

FIG. 4 is a block diagram of a test adapter device according to another embodiment of the disclosure.

Referring to FIG. 4, continuing from the example of FIG. 2, FIG. 4 focuses on illustrating the connection relationship and interaction between the control switch module 110 and the switch modules 130(1) to (4) after an inverter 111 is added. In this embodiment, the control switch module 110 includes two inverters 111(1) and 111(2) disposed between the control signal output ends of the control switch module 110 and the switch modules 130.

The inverter 111(1) is disposed between the output end of the control signal CS and the switch module 130(1), and is used to convert the control signal CS output from the output end of the control signal CS into the inverse control signal CS1 (for example, the control signal CS is at the first level, and the inverse control signal CS1 is at the second level). The inverter 111(2) is disposed between the output end of the control signal CS and the switch module 130(3), and is also used to convert the control signal that is input into the inverse control signal CS3 (for example, the control signal CS is at the first level, and the inverse control signal CS3 is at the second level). The output ends of the control signals CS are directly connected to the switch modules 130(2) and 130(4) without passing through the inverter to output the control signals CS2 and CS4 to the switch modules 130(2) and 130(4) (for example, the control signal CS is at the first level, and the control signals CS2 and CS4 remain at the first level).

This configuration enables the control switch module 110 to control different switch states of the switch modules 130(1) to 130(4) at the same time through the single control signal. For example, when the control switch module 110 outputs the first level through the control signal CS:

The switch modules 130(2) and 130(4) directly receive the control signals CS2 and CS4 at the first level and enter the on state.

The switch modules 130(1) and 130(3) receive the control signals CS1 and CS3 at the second level through the inverters 111(1) and 111(2) and enter the off state.

Conversely, when the control signal CS outputs the second level, the switch modules 130(1) and 130(3) are turned on, and 130(2) and 130(4) are turned off.

In other words, through the configuration of the inverter, the signals received by the switch modules corresponding to the lane groups of each of the PCIe slots with the same sequence numbers are the same. For example, the lane group 151(1) is the first lane group of the PCIe slot 150(1), the lane group 151(3) is the first lane group of the PCIe slot 150(2), the lane groups 151(1) and 151(3) with the same sequence number (both are the first lane group) correspond to the switch modules 130(1) and 130(3) respectively, and the switch modules 130(1) and 130(3) receive the control signals at the same level.

This design greatly simplifies control logic, allowing the control switch module 110 to implement flexible control of the switch modules and the corresponding lane groups by using fewer control signal output ends.

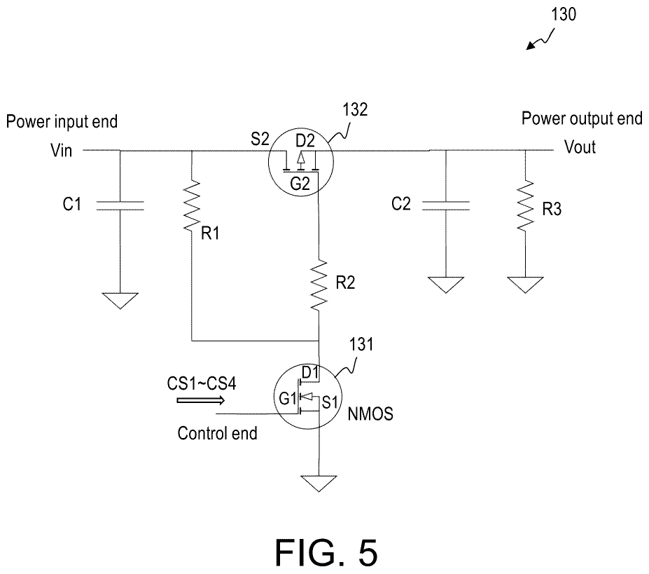

The switch module 130 is a key component in the test adapter device 100 for controlling the power supply state of the interface adapter module 140. Details thereof are described in detail below by using FIG. 5.

FIG. 5 is a schematic circuit diagram of a switch module according to an embodiment of the disclosure.

Referring to FIG. 5, in an embodiment, as shown in FIG. 5, the switch module 130 includes:

A power input end Vin used to receive the power from the power input module 160;

A power output end Vout used to output the power to the corresponding interface adapter module 140;

A control end used to receive the control signals CS1 to CS4 from the control switch module 110;

An N-type metal oxide semiconductor (NMOS) transistor (also called a first switch transistor) 131;

A P-type metal oxide semiconductor (PMOS) transistor (also called a second switch transistor) 132;

A resistor R1 (also called a first resistor), a resistor R2 (also called a second resistor), and a resistor R3 (also called a third resistor); and

A capacitor C1 (also called a first capacitor) and a capacitor C2 (also called a second capacitor).

A source (also called a first node) S1 of the NMOS transistor 131 is grounded, a drain (also called a second node) D1 is connected to a gate (also called a control end) G2 of the PMOS transistor 132 through the resistor R2, a gate (also called a control end) G1 of the NMOS transistor 131 is connected to a control end, and the control end is used to receive the control signal CS1, CS2, CS3, or CS4. A source S2 of the PMOS transistor 132 is connected to the power input end Vin, and a drain D2 is connected to the power output end Vout.

One end of the resistor R1 is connected to the power input end Vin, and the other end is connected to the drain D1 of the NMOS transistor 131 and one end of the resistor R2. The other end of the resistor R2 is connected to the gate G2 of the PMOS transistor 132. A first end of the capacitor C1 is further connected between the source S2 of the PMOS transistor 132 and the power input end Vin, and a second end of the capacitor C1 is grounded. A first end of the capacitor C2 is further connected between the drain D2 of the PMOS transistor 132 and the power output end Vout, and a second end of the capacitor C2 is grounded. A first end of the resistor R3 is further connected between the drain D2 of the PMOS transistor 132 and the power output end Vout, and a second end of the resistor R3 is grounded.

Assuming that there is power input at the end of Vin, different levels of the control signals CS1 to CS4 will result in different working states of the NMOS transistor 131 and the PMOS transistor 132:
(1) When the control signals CS1 to CS4 are at a high level (also called the first level):

The NMOS transistor 131 is turned on, and a voltage of the drain D1 thereof drops close to a ground potential.

A voltage of the gate G2 of the PMOS transistor 132 drops, which is much lower than a voltage (Vin) of the source S2, so that the PMOS is turned on.

A current flows from the power input end Vin to the power output end Vout through the PMOS transistor 132 to supply the power to the corresponding interface adapter module 140.
(2) When the control signals CS1 to CS4 is at a low level (also called the second level):

The NMOS transistor 131 is disabled and is not turned on.

Since there is power input at the end of Vin, through the resistor R1, the voltage of the gate G2 of the PMOS transistor 132 rises close to a voltage of Vin, so that the PMOS is turned off.

The current between the power input end Vin and the power output end Vout is cut off, and the corresponding interface adapter module 140 stops being supplied with the power.

This design allows the control switch module 110 to precisely control the power supply state of each of the interface adapter modules 140 by changing the levels of the control signals CS1 to CS4. In this embodiment, the resistors R1 and R2 form a voltage divider circuit to ensure that the voltage of the gate of the PMOS transistor 132 is in a suitable range. The resistor R3 acts as a pull-down resistor to ensure that the end of Vout does not float when the PMOS transistor 132 is turned off. The capacitors C1 and C2 are used for filtering, reducing power ripple, and improving circuit stability.

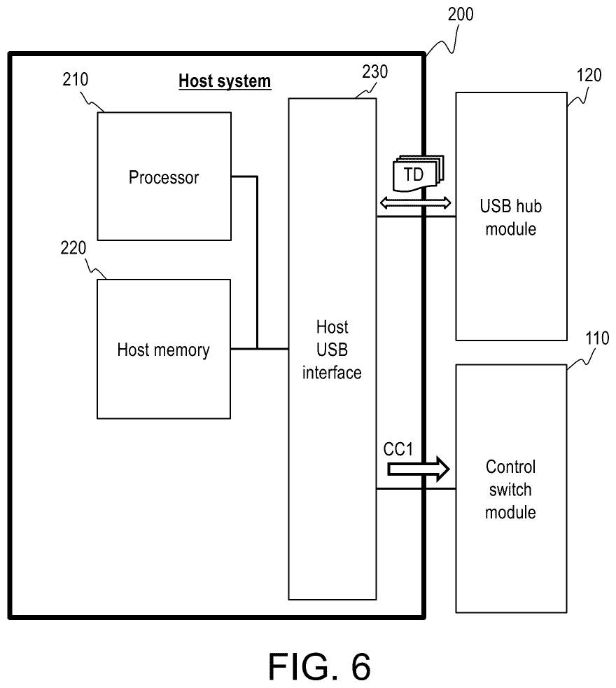

FIG. 6 is a block diagram of a host system according to an embodiment of the disclosure.

Referring to FIG. 6, the host system 200 is a core control unit of the entire test system and is responsible for managing and controlling the test process. In an embodiment, the host system 200 includes: a processor 210 used to execute a test control program and data processing; a host memory 220 used to store a test program, the test data, and the test result; a host USB interface 230 used to perform data communication and control with the test adapter device 100.

The host USB interface 230 includes two main connection ports:

A first port: used to perform bidirectional data transmission with the USB hub module 120. Through the first port, the host system 200 may send the test data TD to the storage device 300 to be tested, and analyze and generate the test result accordingly.

A second port: dedicated to communicate with control switch module 110. Through the second port, the host system 200 may send the test instruction CC1 to the control switch module 110.

The processor 210 is electrically connected to the host memory 220 and the host USB interface 230. The processor 210 may execute various code modules stored in the host memory 220, including but not limited to:

An instruction receiving module used to receive an integrated instruction including information of the target storage device (the storage device to be tested this time) and information of a test object;

A configuration analysis module used to determine the corresponding PCIe slot and the corresponding lane group thereof according to the information of the target storage device, and determine required bandwidth requirements according to the information of the test object;

A resource allocation module used to determine the number of interface adapter modules 140 that are required to be enabled and the corresponding switch module 130 based on an analysis result of the configuration analysis module;

A control signal generating module used to generate the control signal through the control switch module 110 to be sent to the corresponding switch module 130 according to a determination result of the resource allocation module;

A data processing module used to send the test data TD to the enabled interface adapter module 140 through the USB hub module 120, and receive and analyze the response test data TD from the target storage device 300;

A test result analysis module used to generate a test result report according to the analysis result based on the response data.

In the actual operation, the processor 210 sends the test data TD and the corresponding instruction to the USB hub module 120 through the first port of the host USB interface 230 according to the test program stored in the host memory 220. At the same time, the processor 210 sends the test instruction CC1 to the control switch module 110 through the second port to manage the switch states of the switch modules 130(1) to 130(4) in the test adapter device 100, thereby enabling the corresponding lane group for testing. The processor 210 is further responsible for receiving the test data TD returned from the test adapter device 100, performing analysis and processing, and storing the analysis result in the host memory 220.

For example, it is assumed that a format of the test instruction CC1 is as follows:

CC1={operation type, target storage device, target lane group, test mode}

Where:

An operation type: may be “enabled” or “disabled”; a target storage device: specifying the storage device to be tested, such as the “storage device 300(1)” or “storage device 300(2)”; a target lane group: specifying the lane group to be tested, such as the “lane group 151(1)” or “lane group 151(2)”; a test mode: specifying a specific mode of the test, such as a “read performance test”or “write endurance test”.

Exemplary test instruction:

CC1={enabled, storage device 300(1) and 300(3), lane group 151(1) and 151(3), write performance test}

After receiving this test instruction, the control switch module 110 will perform the following processing:

The test instruction CC1 is analyzed to determine that the interface adapter modules corresponding to the lane groups 151(1) and 151(3) of the storage devices 300(1) and 300(2) are required to be enabled.

A system configuration is searched to determine that the lane group 151(1) corresponds to the interface adapter modules 140(1) and 140(3), and the power supply of this module is controlled by the switch modules 130(1) and 130(3).

Generation of the corresponding control signal:
CS1=high level (used to enable the switch module 130(1));
CS2=low level (keeping the disabled state of the switch module 130(2));
CS3=high level (used to enable the switch module 130(3));
CS4=low level (keeping the disabled state of the switch module 130(4)).

The generated control signals CS1 to CS4 are sent to the corresponding switch modules 130(1) to 130(4).

After receiving the high-level signals CS1 and CS3, the switch modules 130(1) and 130(3) are turned on, allowing the power to flow from the power input module 160 to the interface adapter modules 140(1) and 140(3).

After receiving the power, the interface adapter modules 140(1) and 140(3) start to work, so that the lane groups 151(1) and 151(3) may perform interaction of the test data TD with the host system 200, thereby executing a specified write performance test.

At the same time, since CS2 and CS4 are at the low level, the switch modules 130(2) and 130(4) are kept in the off state, the corresponding interface adapter modules 140(2) and 140(4) do not work, and the corresponding lane groups 151(2) and 151(4) do not participate in this test.

In this way, the control switch module 110 may flexibly control working states of different lane groups according to the test instruction CC1 of the host system 200, so as to achieve a purpose of accurately testing a specific lane of the specified storage device. This design not only improves flexibility and accuracy of the test, but also optimizes energy efficiency of the system by selectively enabling required hardware resources.

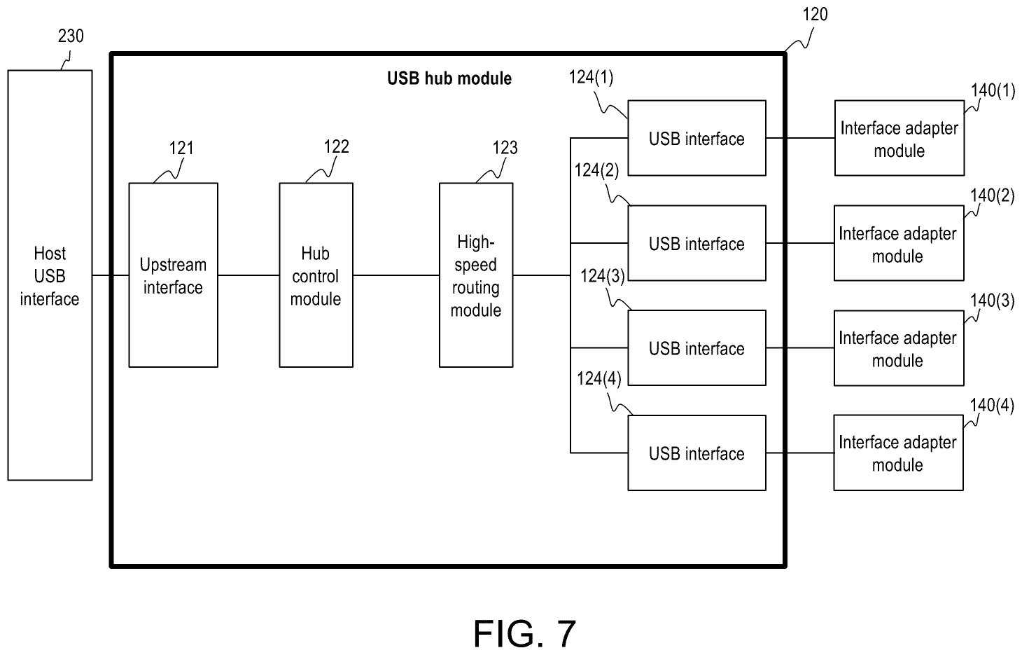

FIG. 7 is a block diagram of a USB hub module according to an embodiment of the disclosure.

In an embodiment, as shown in FIG. 7, the USB hub module 120 is a key component in the test adapter device 100 used to implement data communication between the host system 200 and the interface adapter modules 140.

The USB hub module 120 includes:

An upstream interface 121: used to be connected to the host USB interface 230 of the host system 200. Through this interface, the USB hub module 120 may perform bidirectional data communication with the host system 200.

A hub control module 122: responsible for managing data flow of the entire USB hub module 120. It receives an instruction and data from the upstream interface 121 and determines how to distribute the data to each of downstream USB interfaces.

A high-speed routing module 123: efficiently routing the data to the specified downstream USB interface according to an instruction of the hub control module 122. This module ensures high speed and accuracy of data transmission.

Multiple USB interfaces 124(1), 124(2), 124(3), and 124(4): These are downstream interfaces, connected to the corresponding interface adapter modules 140(1), 140(2), 140(3), and 140(4) respectively. Each of the USB interfaces is responsible for exchanging the data with one interface adapter module.

In an embodiment, a work flow of the USB hub module 120 is as follows:

The host system 200 sends the test data and the instruction corresponding to the test data (e.g., a write instruction for writing the test data to a specific physical address) to the upstream interface 121 through the host USB interface 230.

The upstream interface 121 transmits the received data to the hub control module 122.

The hub control module 122 analyzes the instruction to determine the target interface adapter module of the data.

The hub control module 122 instructs the high-speed routing module 123 to forward the data to the corresponding USB interfaces 124.

The high-speed routing module 123 efficiently distributes the data to the specified USB interface 124(1), 124(2), 124(3) or 124(4) according to the instruction.

Each of the USB interfaces 124 transmits the data to the corresponding interface adapter module 140.

When the interface adapter module 140 has the data returned, the process is performed in a reverse order, and the data is finally transmitted back to the host system 200.

This design enables the USB hub module 120 to efficiently manage data streams of the interface adapter modules 140, achieving parallel communication between the host system 200 and the storage devices 300. Through the collaborative work of the hub control module 122 and the high-speed routing module 123, the system may flexibly allocate bandwidth resources and optimize data transmission efficiency.

In addition, this structural design of the USB hub module 120 also provides a basis for scalability of the system. By adding more USB interfaces 124, the system may be easily expanded to support more interface adapter modules 140, thereby testing more storage devices 300.

In an embodiment, a high-performance chip that supports the latest PCIe standard and USB standard is used for the interface adapter modules 140 in the disclosure. In an embodiment, an ASM2464 chip of ASMedia that supports PCIe 4.0 and USB 3.2 Gen 2 x2 standards is used for the interface adapter modules 140.

The ASM2464 chip has the following features:

The PCIe interface: supporting PCIe 4.0 x4 lanes, and being backward compatible with PCIe 3.0, 2.0 and 1.1 standards. The PCIe 4.0 standard provides a transmission rate of 16 GT/s per lane, and four lanes may provide a total bandwidth of up to 64 GT/s.

The USB interface: supporting the USB 3.2 Gen 2 x2 standard, which may provide a transmission rate of up to 20 Gbps. It is also backward compatible with USB 3.2 Gen 2, USB 3.2 Gen 1, USB 2.0, and USB 1.1 standards.

Protocol conversion: being able to efficiently convert a PCIe protocol to a USB protocol and vice versa to ensure integrity and correctness of the data transmission.

Low latency: using advanced data processing algorithms to minimize delays during the protocol conversion.

Power management: supporting advanced power management functions, which may dynamically adjust power consumption based on workload.

In this embodiment, the configuration of the interface adapter module 140 is as follows:

A PCIe end: connected to two lanes (e.g., the lane group 151(1) or 151(2)) of the PCIe slot 150. Each of the lanes provides a bandwidth of 8 Gbps, and the lane group has a total of 16 Gbps.

A USB end: Output complies with a USB 3.2 standard, and it provides a bandwidth of 20 Gbps, and is connected to one USB interface 124 of the USB hub module 120. That is to say, the USB end may support data transmission requirements of one lane group of the PCIe slot 150 (20Gbps>16 Gbps).

This configuration makes full use of performance of the ASM2464 chip, while also matching an overall design of the test adapter device 100. By using the chip that supports the latest standard, the disclosure ensures that the test adapter device 100 may adapt to the test requirements of the high-performance storage device at present and for some time in the future.

At the same time, since the ASM2464 chip supports downward compatibility with earlier versions of the PCIe and USB standards, the test adapter device 100 may also test the storage devices using older standards. This flexibility enables the test adapter device to adapt to the storage devices of various specifications and generations, greatly expanding an application range thereof. In addition, high-performance characteristics of the ASM2464 chip further ensure that the interface adapter module 140 will not become a bottleneck of the system when the parallel testing on multiple devices is performed. This plays a key role in improving the overall test efficiency, especially when a high-performance PCIe 3.0 SSD is tested.

In another embodiment of the disclosure, the interface adapter module 140 may not only use the ASM2464 chip of ASMedia, but also may use other chips that support PCIe and USB protocol conversion according to specific requirements.

In an embodiment, in the test adapter device 100 of the disclosure, the lanes of the PCIe slot 150 are grouped into multiple lane groups 151. This grouping method is determined based on a maximum supported bandwidth of the USB interface 124 and a maximum supported bandwidth of the PCIe lane to ensure efficiency of the data transmission and optimal utilization of system resources.

Specifically, the total number of lanes grouped into the same lane group 151 is required to satisfy the following condition: the total number of lanes ×the maximum supported bandwidth of each of the lanes ≤the maximum supported bandwidth of the corresponding USB interface.

This design ensures that the interface adapter module 140 does not exceed a bandwidth limit of the USB interface 124 when performing the protocol conversion, thereby avoiding a bottleneck of the data transmission. Specifically, the total number of the lanes grouped into the same lane group is a first number, and the first number is the maximum number of the lanes that may be supported without exceeding the limit of the maximum supported bandwidth of each of the USB interfaces.

This grouping method is described by using a specific example:

It is assumed that the test adapter device 100 has the following specifications:

The PCIe slot 150 supports a PCIe Gen3 x4 standard, and a maximum supported bandwidth of each of the lanes is 8 Gbps.

The USB interface 124 of the USB hub module 120 supports the USB 3.2 standard and has a maximum supported bandwidth of 20 Gbps.

The upstream interface 121 of the USB hub module 120 connected to the host system 200 supports a USB 4.0 standard, and the bandwidth is 40 Gbps.

In this case, the lanes may be grouped in the following manner:

Each of the lane groups 151 may contain 2 PCIe lanes:

2 lanes×8 Gbps=16 Gbps<20 Gbps (the maximum bandwidth of the USB 3.2 interface)

Example of lane grouping:
The lane group 151(1): including a lane lane0 and a lane lane1 of the PCIe slot 150(1)
The lane group 151(2): including a lane lane2 and a lane lane3 of the PCIe slot 150(1)
The lane group 151(3): including a lane lane0 and a lane lane1 of the PCIe slot 150(2)
The lane group 151(4): including a lane lane2 and a lane lane3 of the PCIe slot 150(2)
This grouping method allows the test adapter device 100 to verify two PCIe Gen3 x4 solid-state drives (e.g., the storage devices 300(1) to 300(2)) at the same time. For example, when two solid-state drives are required to be tested at the same time, the following arrangement (testing the specific lane of the storage device) may be used:
A first group: the lane lane0 and the lane lane1 of a first solid-state drive (e.g., the storage device 300(1)), and the lane lane0 and the lane lane1 of a second solid-state drive (e.g., the storage device 300(2))
A second group: the lane lane2 and the lane lane3 of the first solid state drive, and the lane lane2 and the lane lane3 of the second solid state drive

By controlling each of the switch modules 130 by the control signal sent by the control switch module 110, different interface adapter modules 140 may be selectively enabled or disabled, thereby controlling which group of lanes are to be verified. Each of the interface adapter module 140 corresponds to two lanes (one lane group) respectively, so that the control switch module 110 may flexibly control which group of lanes are to be verified.

This design makes full use of bandwidth capability of the USB hub module 120. Although the upstream interface 121 (or the host USB interface 230) supports the USB 4.0standard of 40 Gbps, in practice only performance of 4 lanes (4×8 Gbps=32 Gbps) may be fully used. This configuration not only optimizes the utilization of the system resources, but also provides flexible test configuration options, allowing combinations of different lanes of multiple solid-state drives to be tested at the same time, greatly improving the test efficiency and flexibility.

Based on the above, the technical utility of the disclosure is mainly reflected in the following aspects:
(1) Achieving the simulated hot-plugging function of the storage device with the PCIe interface:

The disclosure successfully implements a simulated hot-plugging operation of the storage device with the PCIe interface through an innovative design of the combination of the power control and the USB hub module 120. Although it is not physically hot-pluggable, this design cleverly solves an issue that the PCIe solid-state drive does not support hot-plugging in conventional testing methods. Specifically, in the disclosure, the power supply state of the interface adapter module 140 is managed through the control switch module 110 and the switch module 130, thereby achieving electrical isolation and reconnection of the storage device with the PCIe interface. This method enables the test system to simulate effects of hot-plugging without physically removing the storage device. This innovative design brings the following advantages: (a) Improving the test flexibility: A tester may “disconnect” or “connect” the storage device under test through software control without shutting down or restarting the test system. (b) Increasing the test efficiency: reducing time and labor costs of physical plugging operations, speeding up the test process. (c) Reducing hardware loss: reducing physical deterioration in the PCIe interface and the storage device caused by frequent physical plugging. (d) Precise control: Through the software-controlled simulated hot-plugging, more precise timing control and more complex test scenario simulation may be implemented.
(2) Supporting the parallel testing on the storage devices:

The design in the disclosure allows connection and testing of the storage devices with the PCIe interfaces at the same time. Through cooperation of the USB hub module 120 and the interface adapter modules 140, the system may process data streams of the storage devices at the same time, which significantly improves the test efficiency. This feature solves an issue in existing technologies that it is difficult to verify the solid-state drives at the same time.
(3) Flexible bandwidth allocation and lane management:

In the disclosure, an innovative lane grouping method is used, which may flexibly allocate the resources according to the bandwidth of the USB interface and the bandwidth of the PCIe lane. This design allows the system to flexibly switch between testing the partial performance of the devices and testing the full performance of a small number of devices, making full use of the bandwidth resources of the system and improving the resource utilization.
(4) Strong adaptability and compatibility with multiple standards:

The disclosure supports the latest PCIe and USB standards while maintaining the downward compatibility. This enables the test adapter device to adapt to the storage devices of different specifications and generations, enhancing versatility and long-term use value of the system.
(5) Simplifying requirements for a test device:

In the disclosure, through the PCIe to USB conversion, ordinary computers without the PCIe slots may also test the storage devices with the PCIe interfaces. This greatly reduces the hardware requirements for the test device, making the testing process more convenient and economical.
(6) Precise control and management:

Through the design of the control switch module 110 and the switch module 130, the disclosure implements the precise control of each of the interface adapter modules 140. This design not only improves reliability of the system, but also provides more flexibility and controllability for the testing process.

Lastly, it is to be noted that: the embodiments described above are only used to illustrate the technical solutions of the disclosure, and not to limit the disclosure; although the disclosure is described in detail with reference to the embodiments, those skilled in the art should understand: it is still possible to modify the technical solutions recorded in the embodiments, or to equivalently replace some or all of the technical features; the modifications or replacements do not cause the essence of the corresponding technical solutions to deviate from the scope of the technical solutions of the embodiments.

What is claimed is:

1. A test adapter device, suitable for testing a plurality of storage devices, comprising:
a USB hub module electrically connected to a host USB interface of a host system, wherein the USB hub module comprises a plurality of USB interfaces;
a plurality of PCIe slots configured to be electrically connected to a plurality of storage devices to be tested, wherein each of the PCIe slots comprises a plurality of lanes, and the lanes of each of the PCIe slots are grouped into a plurality of lane groups;
a plurality of interface adapter modules, wherein a first interface of each of the interface adapter modules is electrically connected to one of the lane groups of one of the PCIe slots, and a second interface is electrically connected to one of the USB interfaces, wherein each of the interface adapter modules is configured for signal conversion between one of the lane groups in the PCIe slot and the USB interface;
a plurality of switch modules electrically connected to the interface adapter modules respectively to control a power supply state of the corresponding interface adapter module; and
a control switch module electrically connected to the switch modules to control a switch state of each of the switch modules to enable a corresponding target lane group corresponding to the PCIe slots.

2. The test adapter device according to claim 1, wherein the control switch module comprises:
a plurality of control signal output ends electrically connected to the switch modules to transmit a plurality of control signals to the switch modules respectively, so as to control the different switch states of the switch modules, wherein each of the control signals comprises a first level or a second level.

3. The test adapter device according to claim 1, wherein the control switch module comprises:
one or more inverters disposed between an output end of the control switch module for outputting a control signal and the switch modules to convert the control signal that is input into an inverse control signal, so that some of the switch modules among the switch modules receive the inverse control signal, thereby controlling the different switch states of the switch modules at the same time through the single control signal.

4. The test adapter device according to claim 3, wherein
the control signals received by the switch modules corresponding to the lane groups of each of the PCIe slots with same sequence numbers are the same.

5. The test adapter device according to claim 1, wherein the test adapter device further comprises: a power input module externally connected to an external power source to provide power to the interface adapter modules, wherein the power input module is electrically connected to the interface adapter modules respectively through the switch modules.

6. The test adapter device according to claim 5, wherein each of the switch modules comprises:
a first switch transistor;
a second switch transistor;
a power input end configured to be connected to the power input module; and
a power output end configured to be connected to the corresponding interface adapter module,
wherein a first node of the first switch transistor is connected to the power input end, a second node of the first switch transistor is connected to the power output end, a second node of the second switch transistor is connected to a control end of the first switch transistor, a first node of the second switch transistor is grounded, and a control end of the second switch transistor is configured to receive a control signal or an inverse control signal output by the control switch module.

7. The test adapter device according to claim 6, wherein
the first switch transistor is a PMOS transistor, wherein the first node of the first switch transistor is a source of the PMOS transistor, the second node of the first switch transistor is a drain of the PMOS transistor, and the control end of the first switch transistor is a gate of the PMOS transistor; and
the second switch is an NMOS transistor, wherein the first node of the second switch transistor is a source of the NMOS transistor, the second node of the second switch transistor is a drain of the NMOS transistor, and the control end of the second switch transistor is a gate of the NMOS transistor.

8. The test adapter device according to claim 7, wherein the switch module further comprises: a first resistor, a second resistor, a third resistor, a first capacitor, and a second capacitor,
wherein the drain of the NMOS transistor is connected to the power input end through the first resistor, and the drain of the NMOS transistor is connected to the gate of the PMOS transistor through the second resistor,
wherein a first end of the first capacitor is connected between the source of the PMOS transistor and the power input end, and a second end of the first capacitor is grounded,
wherein a first end of the second capacitor is connected between the drain of the PMOS transistor and the power output end, and a second end of the second capacitor is grounded,
wherein a first end of the third resistor is connected between the drain of the PMOS transistor and the power output end, and a second end of the third resistor is grounded.

9. The test adapter device according to claim 1, wherein the USB hub module further comprises:
an upstream interface configured to be connected to the host USB interface;
a hub control module configured to manage data flow; and
a high-speed routing module configured to distribute data from the hub control module to the corresponding USB interface according to an instruction of the hub control module.

10. The test adapter device according to claim 1, wherein a total number of the lanes grouped into the same lane group is a first number, and the first number is a maximum number of the lanes supported without exceeding a limit of a maximum supported bandwidth of each of the USB interfaces.
